(19) United States
(12) Patent Application Publication
(10) Pub. No.: US 2008/0092673 A1
(43) Pub. Date: Apr. 24, 2008

(54) Device For Fastening A Rain Sensor On A Support

(75) Inventors: Mathias Hansel, Rummingen (DE); Joseph Portella Ribera, Habsheim (FR); Laurent Chouvet, Neuenburg (DE)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/571,691

(22) PCT Filed: Jun. 9, 2005
(86) PCT No.: PCT/EP05/06195

§ 371 Date: Oct. 3, 2007

(30) Foreign Application Priority Data
Jul. 7, 2004 (DE) 10 2004 032 749.1

(51) Int. Cl. G01D 11/30

(52) U.S. Cl. 73/866.5

(57) ABSTRACT

The invention relates to a device for fastening a rain sensor (3) to a support. Said device comprises a base (1) that is provided with an adhesive on the side facing the support for fastening it on the support, two lateral webs (6, 7) aligned in a substantially perpendicular manner in relation to abase plate (8) of a base (1), two opposite neck webs for fixing a neck section (5) of the main sensor (3) and two tilted lateral tongues (9, 10) for fixing a spheroid top section (4) of the rain sensor (3). The device is provided with a cover part (2) which comprises edge webs that can be engaged with the lateral webs (6, 7) of the base (1) and a resilient spring tongue (12) that is biased and rests against the top section (4) of an interposed rain sensor (3). The inventive device has an especially compact and esthetically appealing design and allows for a comparatively high contact pressure.

### BACKGROUND OF THE INVENTION

The invention relates to a device for fastening a rain sensor to a support.

One such device is known from EP 1 040 962 A2. In that device, a base part is configured in a ring shape and surrounds the rain sensor. A cover part in the form of the stem of a rear view mirror can be clipped onto the base part.

Known from DE 100 60 447 A1 is an interior mirror system with a built-in sensor system and the various fastening means used to interconnect the parts of the interior mirror system and the sensor system.

In addition, devices for fastening a rain sensor to a support are known in practice, and usually comprise a cage part that surrounds a disk-shaped head portion of a rain sensor, is glued to a pane of glass serving as a support, and carries a spring that acts on the head portion to press it against the pane of glass.

### SUMMARY OF THE INVENTION

The present invention provides a device for fastening a rain sensor to a support that is distinguished by a particularly small and therefore esthetically pleasing design and a comparatively high pressing force.

By virtue of the fact that in the inventive device, the rain sensor comprising a neck portion and a roundish head portion is interposed between a base part and a cover part and its head portion is held in place by the obliquely set edge tongues and the neck portion by neck webs, the head portion being pressed against the support by the pressure-exerting resilient tongue and the force so applied being conducted into the adhesive coating via the edge webs of the cover part and the side webs of the base part, the result is a comparatively slender design accompanied by relatively high pressing forces.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of an inventive device with a rain sensor interposed between a base part and a cover part;

FIG. 2 is a perspective view of the base part according to FIG. 1, seen from below;

FIG. 3 is a perspective view of the cover part according to FIG. 1;

FIG. 4 is a cross section of the exemplary embodiment according to FIGS. 1 to 3; and

FIG. 5 is a longitudinal section of the exemplary embodiment according to FIGS. 1 to 4.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

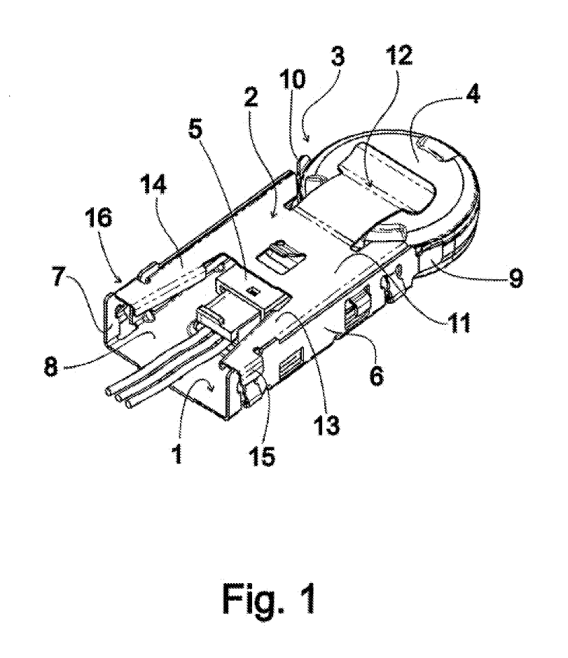

FIG. 1 is a perspective view of an exemplary embodiment of an inventive device, comprising a base part 1 and a cover part 2 which are detachably connected to each other. In the representation of FIG. 1, a rain sensor 3 having a roundish head portion 4 and a neck portion 5 appended to said head portion 4 is interposed between base part 1 and cover part 2.

In the exemplary embodiment according to FIG. 1, base part 1 comprises two side webs 6, 7 disposed parallel to each other and oriented at right angles to a base plate 8. Appended to the side webs 6, 7 at one end are edge tongues 9, 10 oriented at angles to said side webs 6, 7 and splayed outwardly at a shallow angle. When the inventive device is used according to the invention, the edge tongues 9, 10, each of which has an edge region that is bent outwardly in the insertion direction of the rain sensor 3, rest against the outer peripheral surface of the head portion 4 belonging to the rain sensor 3 and disposed adjacent the inventive device, and thereby secure it particularly against lateral movement.

The cover part 2 is configured with a cover plate 11 at the end of which is formed a pressure-exerting resilient tongue 12, which in the intended arrangement of the rain sensor 3 rests on head portion 4 and presses it against a pane of glass (not shown in FIG. 1) serving as a support. Cover part 2 is further provided with longitudinal portions 13, 14, oriented substantially at right angles to cover plate 11 and pointing away from pressure-exerting resilient tongue 12, which are configured with edge regions bent in the direction of base part 1, and at the free ends of which are formed respective clasping tongues 15, 16, which are set at right angles to cover plate 11 and which in the assembled arrangement of the exemplary embodiment clasp the side webs 6, 7 of base part 1.

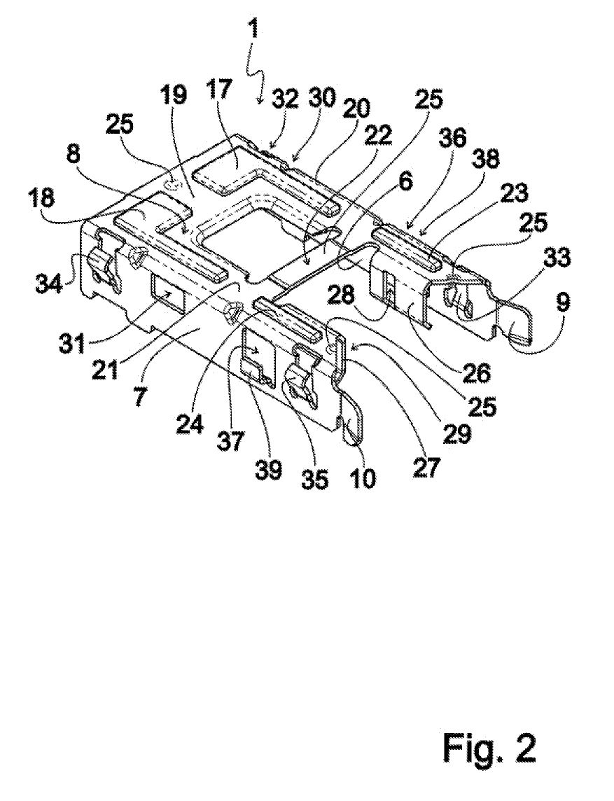

FIG. 2 is a perspective view of the base part 1 according to FIG. 1, looking from below at two L-shaped adhesive regions 17, 18 of an adhesive coating, which lie with their short, broader legs in the longitudinal direction of a transverse portion 19 of base plate 8 that is oriented at right angles to side webs 6, 7, and with their long, narrower legs in the longitudinal direction of longitudinal portions 20, 21 of base plate 8, which are also oriented at right angles to side webs 6, 7. A central web 22 is formed between longitudinal portions 20, 21, in the region of the ends of the long legs of adhesive regions 17, 18. Comparatively narrow, elongated adhesive regions 23, 24 of the adhesive coating are present on end regions belonging to longitudinal portions 20, 21 and extending away from transverse portion 19 beyond central web 22.

The adhesive coating is implemented in the form of a so-called hot-melt adhesive, which is applied at a relatively low temperature at which it incipiently melts onto and adheres to base part 1, and, after being heated to a relatively high temperature at which it melts completely, to liquefaction, bonds the base part 1 to a support such as for example a pane of glass. To ensure a constant distance between base part 1 and the support, spacers 25 are provided in transverse portion 19, longitudinal portions 20, 21 and central web 22 of base plate 8. In the exemplary embodiment shown, the terminating edges of transverse portion 19 and longitudinal portions 20, 21 are for the most part configured with rounded bends around adhesive regions 17, 18, 23, 24, to obtain controlled flow properties, among other purposes.

The neck webs 26, 27, between which the neck portion 5 of the rain sensor 3 is to be arranged are added in the end regions of longitudinal portions 20, 21, substantially perpendicular thereto and consequently parallel to side webs 6, 7. Neck webs 26, 27, which are bent at their ends, comprise, as latching means, detent recesses 28, 29 arranged mutually offset in the longitudinal direction of base part 1.

It can further be seen from FIG. 2 that formed in side webs 6, 7 of base part 1 are retaining openings 30, 31, which serve to engage a retaining device on the incipient melting of the hot-melt adhesive in adhesive regions 17, 18, 23, 24. Also formed at the ends of side webs 6, 7 are detent tongues 32, 33, 34, 35 of a latching arrangement, which protrude laterally outwardly beyond side webs 6, 7. Finally, configured on the side webs 6, 7 are tongue recesses 36, 37 and laterally protruding stop tongues 38, 39 that regionally cover tongue recesses 36, 37.

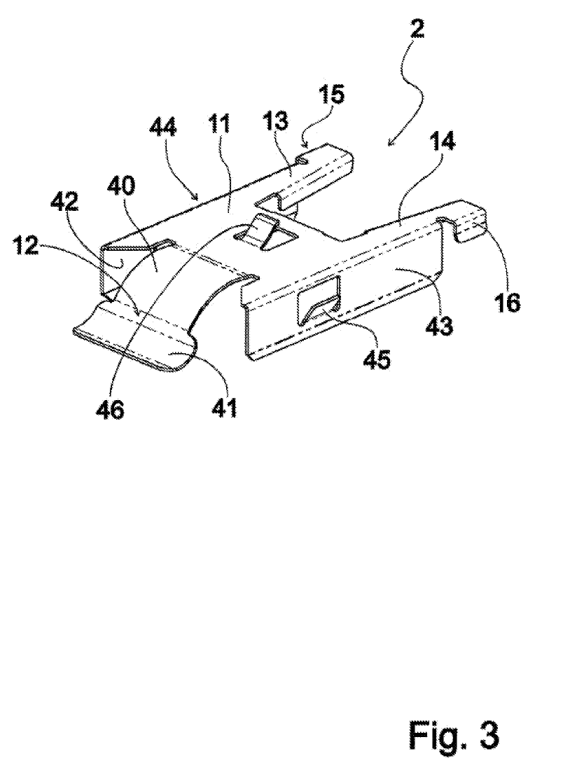

FIG. 3 is a perspective view of the cover part 2 of the exemplary embodiment according to FIG. 1. As is particularly clear in FIG. 3, pressure-exerting resilient tongue 12 comprises, joined to cover plate 11, a resilient portion 40 that is bent inwardly away from cover plate 11, and a bearing portion 41, which is bent oppositely to the inflection of resilient portion 40 and which comes to rest, by its side facing away from cover plate 11, on the head portion 4 of the rain sensor 3.

Cover part 2 is further provided with edge webs 42, 43 running substantially parallel to each other and oriented at right angles to cover plate 11, and extending between pressure-exerting resilient tongue 12 and clasping tongues 15, 16. Edge webs 42, 43 are each provided with a splayed tongue 44, 45 that juts laterally outwardly from the respective edge web 42, 43. Said splayed tongues 44, 45 are dimensioned and positioned such that in the assembled arrangement of base part 1 and cover part 2, they each engage in a respective tongue recess 36, 37 provided in a side web 6, 7 of base part 1 and bear against the appurtenant stop tongue 38, 39. By this means, in combination with the lapping-over of clasping tongues 15, 16, cover part 2 can be detachably secured in base part 1 with virtually no play.

Finally, it can be appreciated from FIG. 3 that formed in cover plate 11 is a counter-resilient tongue 46 that protrudes from cover plate 11 in a direction away from base part 1.

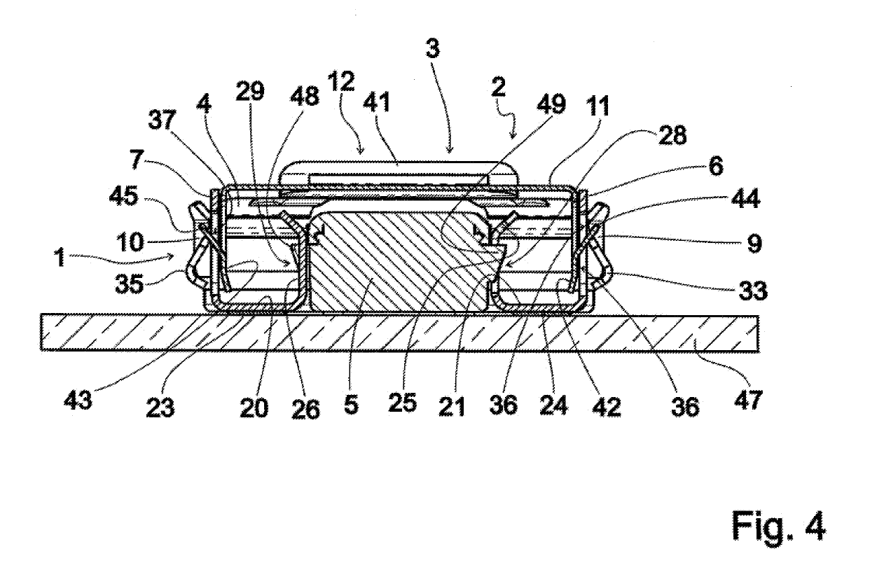

FIG. 4 is a cross section of the exemplary embodiment of an inventive device with interposed rain sensor 3 according to FIGS. 1 to 3, mounted on a glass pane 47 serving as a support, for example in the form of a windshield or rear window of a motor vehicle. It can be appreciated from FIG. 4, for one thing, that stop lugs 48, 49, which are appended to the neck portion 5 of rain sensor 3 and which are mutually offset in the longitudinal direction of said neck portion 5, engage in the stop recesses 28, 29 and secure the rain sensor 3. It can further be seen from FIG. 4 that the side webs 6, 7 of base part 1 and the edge webs 42, 43 of cover part 2 bear against each other as splayed tongues 44, 45 engage in tongue recesses 36, 37, causing splayed tongues 44, 45 to be braced outwardly against stop tongues 38, 39, as can be appreciated from FIG. 1, and that as a result, the force exerted by pressure-exerting resilient tongue 12 on head portion 4 of rain sensor 3 is conducted into base part 1 via the entire edge face. Adhesive regions 17, 18, 23, 24 thus are substantially evenly loaded over their entire area of connection to glass pane 47, thus preventing linear separation beginning at the edge face.

From an overall standpoint, it can be clearly seen from FIG. 4 that the width of the inventive device is substantially the same as the diameter of head portion 4 of rain sensor 3, and is therefore comparatively narrow.

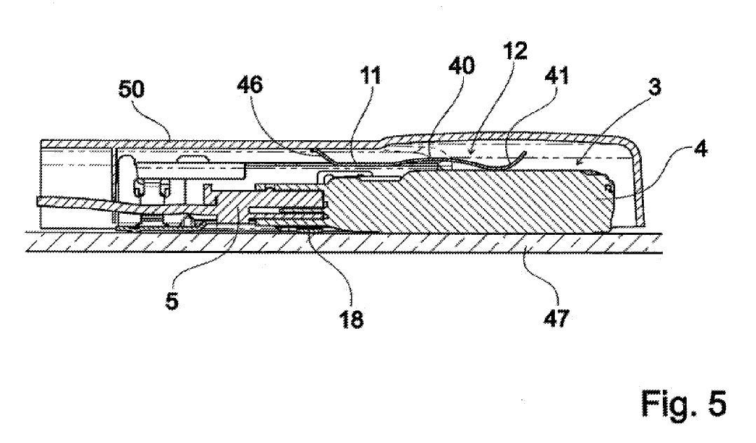

FIG. 5 is a longitudinal section of the exemplary embodiment of an inventive device with interposed rain sensor 3 according to FIGS. 1 to 4, onto which a covering cap 50 has been snapped, engaging with the stop tongues 32, 33, 34, 35. It can be seen especially clearly from FIG. 5 that counter-resilient tongue 46 is biased against covering cap 50 and that the latter is therefore fastened without play. It can further be appreciated from FIG. 5 that the resilient portion 40 of pressure-exerting resilient tongue 12, which is bent inwardly in the direction of edge webs 42, 43, is distinctly flattened, while pressure-exerting resilient tongue 12 exerts a comparatively high pressing force on head portion 4 that is sufficient to enable the rain sensor 3 to perform its measurement task while at the same time preventing artifacts at the interface with glass pane 47.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-7. (canceled)

8. A device for fastening a rain sensor (3) having a head portion (4) and a neck portion (5) to a support (47), said device comprising:
a base part (1), comprising:
a base plate (8);
at least two side webs (6, 7) oriented substantially at right angles to said base plate (8);
an adhesive coating (17, 18, 23, 24) provided on a side of said base plate (8) facing said support (47) for fastening said base part (1) to said support (47);
at least two neck webs (26, 27) disposed opposite each other and oriented parallel to said side webs (6, 7) for securing the neck portion (5) of the rain sensor (3); and
at least two edge tongues (9, 10) appended to said side webs (6, 7), said edge tongues (9, 10) oriented at angles to said side webs (6, 7) and pitched outwardly therefrom at a shallow angle for securing the head portion (4) of the rain sensor (3); and
a cover part (2), comprising:
edge webs (42, 43) engageable with said side webs (6, 7) of said base part (1); and
a pressure-exerting resilient tongue (12) formed onto one end of said cover part (2) and including a resilient portion (40) bent inwardly away from said cover plate (11) in the direction of said edge webs (42, 43), and a bearing portion (41) joined to said resilient portion (40) that is biased to bear against said head portion (4) of the rain sensor (3).

9. The device of claim 8, wherein said side webs (6, 7) and said edge webs (42, 43) are engageable with each other via an arrangement of tongue recesses (36, 37) and splayed tongues (44, 45) engaging in said tongue recesses (36, 37).

10. The device of claim 8, wherein said base plate (8) comprises a marginal transverse portion (19) extending between said side webs (6, 7), and at least two longitudinally extending longitudinal portions (20, 21) formed on said side webs (6, 7) on which a plurality of adhesive regions (17, 18, 23, 24) forming said adhesive coating are present.

11. The device of claim 8, wherein said bearing portion (41) is bent oppositely to an inflection of said resilient portion (40).

12. The device of claim 8, wherein said cover part (2) comprises clasping tongues (15, 16) that clasp said side webs (6, 7) of said base part (1).

13. The device of claim 8, wherein said neck webs (26, 27) comprise latching means (28, 29) for engaging with the neck portion (5) of the rain sensor (3).

14. The device of claim 8, further comprising a latching arrangement (32, 33, 34, 35) for engaging with a covering cap (50).
